(19) United States
(12) Patent Application Publication
(10) Pub. No.: US 2025/0028959 A1
(43) Pub. Date: Jan. 23, 2025

(54) DEVICE AND METHOD FOR SEARCHING NEURAL NETWORK ARCHITECTURE USING SUPERNET

(71) Applicant: UIF (University Industry Foundation), Yonsei University, Seoul (KR)

(72) Inventors: Bum Sub HAM, Seoul (KR); Young Min OH, Seoul (KR)

(21) Appl. No.: 18/455,183

(22) Filed: Aug. 24, 2023

(30) Foreign Application Priority Data
Jul. 18, 2023 (KR) 10-2023-0093372

(51) Int. Cl. G06N 3/082; G06N 3/048

(52) U.S. Cl. CPC G06N 3/082; G06N 3/048

(57) ABSTRACT

A method for searching a neural network architecture using supernets comprises the steps of: (a) searching for subnets that can be extracted from a set search space; (b) counting the number of non-linear activation functions included in each subnet for each of the searched subnets; (c) grouping the searched subnets based on the counted number of non-linear activation functions; (d) assigning the subnet groups to multiple supernets; (e) searching for a neural network having an optimal architecture based on operation blocks of the subnet groups assigned to each of the multiple supernets.

### CROSS-REFERENCE TO RELATED APPLICATIONS

This application claims priority under 35 U.S.C. § 119 (a) to Korean Patent Application No. 10-2023-0093372, filed on Jul. 18, 2023, with the Korean Intellectual Property Office, the disclosure of which is incorporated herein in its entirety by reference.

### BACKGROUND

### 1. Technical Field

The present disclosure relates to a device and method for searching a neural network architecture, and more particularly to a device and method for searching a neural network architecture using supernets.

### 2. Description of the Related Art

Recently, neural network models such as a convolutional neural network (CNN) have achieved high performance in a variety of tasks, and neural network models are being used to solve problems in a wider variety of tasks.

In order to design a neural network model that achieves high performance, experts must go through considerable trial and error, and therefore, designing a neural network model that achieves high performance requires enormous cost and time.

Neural network architecture search has been studied to minimize expert intervention in the design of neural network models that achieve high performance, and neural network architecture search is a technique that automatically finds a neural network model with the optimal architecture within the search space.

Initially, reinforcement learning or evolutionary algorithm was used to search neural network architectures, but since the number of subnets that can be extracted from the search space of a commonly used neural network exceeded 1012, there was a problem in that it took an enormous amount of time to search for an optimal neural network using the above methods.

A method using one or more supernet(s) was proposed for more efficient neural network architecture search. A one-shot neural network architecture search method using one supernet and a few-shot neural network architecture search method using multiple supernets were proposed.

However, the one-shot neural network architecture search forced subnets to use the same weight, which resulted in interference between networks, which limited the search for the optimal neural network architecture.

In addition, when using the few-shot neural network architecture search, the problem of interference between networks is alleviated, but there is a problem that a large amount of computation is required to separate the search space.

### SUMMARY OF THE INVENTION

An object of the present disclosure is to propose a device and method for searching a neural network architecture that can search for an optimal neural network architecture with relatively simple operations while using multiple supernets.

Another object of the present disclosure is to propose a device and method for searching a neural network architecture that can effectively search for a neural network with the optimal architecture by searching the neural network architecture by reflecting the topological properties of subnets while using multiple supernets.

According to one aspect of the present disclosure, conceived to achieve the objectives above, a method for searching a neural network architecture is provided, the method comprising the steps of: (a) searching for subnets that can be extracted from a set search space; (b) counting the number of non-linear activation functions included in each subnet for each of the searched subnets; (c) grouping the searched subnets based on the counted number of non-linear activation functions; (d) assigning the subnet groups to multiple supernets; (e) searching for a neural network having an optimal architecture based on operation blocks of the subnet groups assigned to each of the multiple supernets.

The step (c) includes grouping subnets with the same number of non-linear activation functions into the same group.

The step (b) includes counting the number of non-linear activation functions by counting the number of operation blocks set to use the non-linear activation function among the operation blocks included in the extracted subnets.

When the extracted subnet is a neural network having a parallel architecture, the number of non-linear activation functions is counted for each path of the parallel architecture, and the number of non-linear activation functions of the path having the largest number of non-linear activation functions among a plurality of paths is determined as the number of non-linear activation functions of the corresponding subnet.

In step (d), subnets belonging to the same group are assigned to the same supernet.

The number of supernets is determined for each subnet group based on the variance value of the distribution after obtaining the distribution of the number of subnets included in the group.

In order to determine the number of supernets, groups including subnets greater than a preset critical value are searched among the plurality of groups grouped in step (c), and the number of groups including subnets greater than the preset critical value is determined as the number of supernets.

In step (e), each of the multiple supernets extracts subnets corresponding to the number of non-linear activation functions associated with the group assigned to the corresponding supernet, thereby searching for a neural network having an optimal architecture.

According to another aspect of the present disclosure, conceived to achieve the objectives above, a device for searching a neural network architecture is provided, the device including: a processor; and at least one memory connected to the processor, wherein the processor executes the steps of: (a) searching for subnets that can be extracted from a set search space; (b) counting the number of non-linear activation functions included in each subnet for each of the searched subnets; (c) grouping the searched subnets based on the counted number of non-linear activation functions; (d) assigning the subnet groups to multiple supernets; (e) searching for a neural network having an optimal architecture based on operation blocks of the subnet groups assigned to each of the multiple supernets.

According to embodiments of the present disclosure, there is an advantage in that the optimal neural network architecture can be searched through relatively simple operations while using multiple supernets.

In addition, according to embodiments of the present disclosure, there is an advantage in that a neural network with the optimal architecture can be effectively searched for by searching the neural network architecture by reflecting the topological properties of the subnets while using multiple supernets.

### BRIEF DESCRIPTION OF THE DRAWINGS

FIG. 1 is a diagram for describing the concept of a supernet.

FIG. 2 is a diagram for describing a method for searching an optimal neural network architecture using a plurality of supernets.

FIG. 3 is a flowchart showing the overall process of a neural network architecture search method using supernets according to an embodiment of the present disclosure.

FIG. 4 is a diagram showing an example of counting the number of non-linear activation functions according to an embodiment of the present disclosure.

FIG. 5 is a diagram showing another example of counting the number of non-linear activation functions according to an embodiment of the present disclosure.

FIG. 6 is a graph showing an example of the distribution of the number of subnets for each subnet group according to an embodiment of the present disclosure.

FIG. 7 is a diagram showing another example of assigning subnet groups to supernets according to an embodiment of the present disclosure.

FIG. 8 is a flowchart showing the overall process of a neural network architecture search method using supernets according to another embodiment of the present disclosure.

### DETAILED DESCRIPTION OF THE INVENTION

In order to fully understand the present disclosure, operational advantages of the present disclosure, and objects achieved by implementing the present disclosure, reference should be made to the accompanying drawings illustrating preferred embodiments of the present disclosure and to the contents described in the accompanying drawings.

Hereinafter, the present disclosure will be described in detail by describing preferred embodiments of the present disclosure with reference to accompanying drawings. However, the present disclosure can be implemented in various different forms and is not limited to the embodiments described herein. For a clearer understanding of the present disclosure, parts that are not of great relevance to the present disclosure have been omitted from the drawings, and like reference numerals in the drawings are used to represent like elements throughout the specification.

A neural network consists of multiple layers, and performs preset neural network operations for each layer. The number of layers and the type of neural network operation performed at each layer are set in advance, and training of the neural network is performed based on the set number of layers and type of neural network operation at each layer.

Here, the type of neural network operation may include types of neural network operation and the kernel size applied to the neural network operation.

It is difficult to predict in advance the number of layers, kernel size, and type of neural network operation for efficient training of the target neural network. This is because the efficiency of the above parameters can be checked only after learning has taken place.

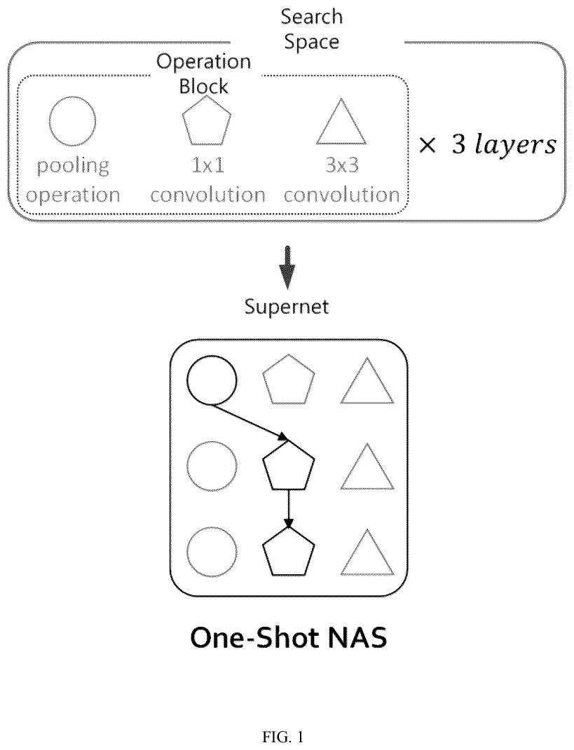

Supernet was introduced to solve this problem, and FIG. 1 is a diagram for describing the concept of a supernet.

Referring to FIG. 1, an example of a search space is shown. In the present embodiment, the search space represents the types of parameters needed to set up a neural network. For example, the number of layers, the type of neural network operation, and the type of kernel size in kernel operation may be included in the search space.

In FIG. 1, a case is shown where the number of layers is three, types of neural network operations include a pooling operation and a convolution operation, and the convolution operation uses two types of kernels (1×1 convolution, 3×3 convolution).

In this embodiment, operation modules existing in the search space are defined as operation blocks. In other words, the pooling operation module, 1×1 convolution operation module, and 3×3 convolution operation module are all independent operation blocks.

One subnet can be selected by appropriately selecting these operation blocks and sampling the path that passes through specific operation blocks, and a supernet is a network that includes all operation blocks in the search space and is set up to select the most efficient subnet among the subnets extracted through sampling.

For convenience of explanation, a very simple search space and a simple supernet are shown in FIG. 1, but the number of operation blocks used in an actual neural network is very large, and therefore the number of subnets sampled in a supernet is also large. In actual neural networks, the number of sampled subnets is often 1012.

In the supernet conceptually shown in FIG. 1, each row represents a layer. Since the preset number of layers is 3, FIG. 1 shows a supernet with three rows. One or more operation blocks are selected for each row, and one subnet can be extracted by connecting the operation blocks selected for each row.

Training of the supernet is done through some extractable subnets. For example, if the number of subnets that can be extracted is 1012, a supernet can be trained by extracting about 1000 subnets and then using their performance as a label.

Using the supernet trained in this way, a neural network (one of the subnets) with the optimal architecture can be selected, and it is possible to search an effective neural network architecture without expert trial and error and without spending a lot of time.

However, the neural network architecture search using the supernet described with reference to FIG. 1 is performed under the assumption that the weight for each operation block is the same. As a result, since it selects an effective subnet while the operation blocks of different subnets are set to use the same weight, it is difficult to be sure that the performance of the subnet searched in this way is optimal.

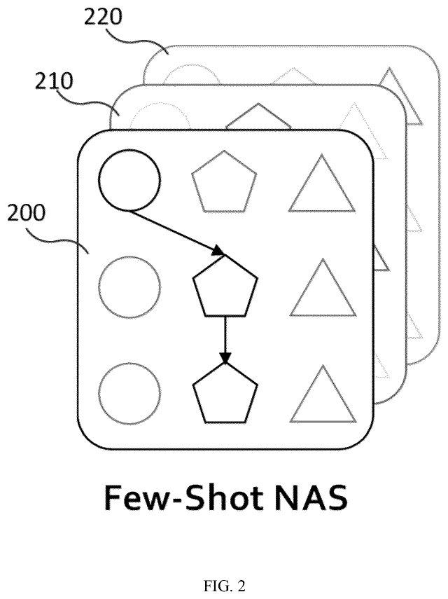

FIG. 2 is a diagram for describing a method for searching an optimal neural network architecture using a plurality of supernets.

To solve the problem of supernets as shown in FIG. 1, a method of searching for an optimal neural network architecture using multiple supernets has been proposed. Referring to FIG. 2, multiple supernets 200, 210, and 220 are shown. In the previously proposed method for searching a neural network using multiple supernets, the entire search space was separated to create multiple supernets, and then each supernet independently searched for the optimal neural network architecture.

In FIG. 2, the first supernet 200, the second supernet 210, and the third supernet 220 are supernets formed by separating the entire search space. The multiple supernets 200, 210, and 220 are not separated into completely different operation modules, and in the existing system for searching a neural network using multiple supernets, there was a problem that an enormous amount of operation was required to quantify the interference between neural networks and thereby separate the groups to be assigned to each supernet.

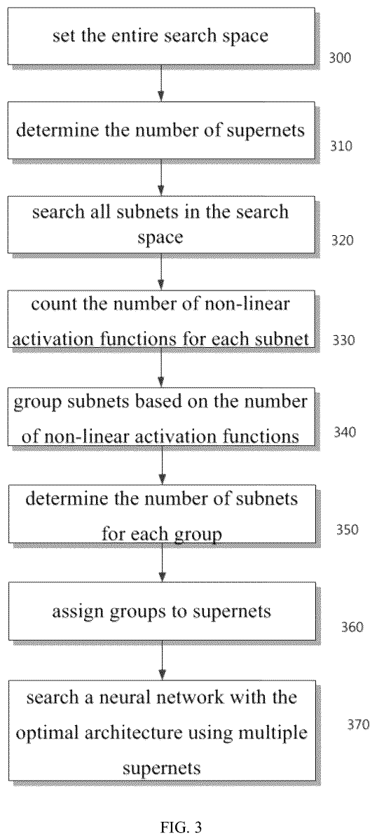

FIG. 3 is a flowchart showing the overall process of a neural network architecture search method using supernets according to an embodiment of the present disclosure.

Referring to FIG. 3, the entire search space is set (step 300). The type of operation module, number of layers, kernel size of each operation module, etc. are set to the entire search space.

Once the search space is set, the number of supernets is determined (step 310). The number of supernets may be arbitrarily set by the designer.

Once the number of supernets is determined, all subnets in the search space are searched (step 320). All configurable subnets are extracted from the search space. For example, if six operation modules are used for layers 1-6, and 7 operation modules are used for layers 7-15, the number of searched subnets can be 66×715

When subnet search is completed, the number of non-linear activation functions for each subnet is counted (step 330). A non-linear activation function is an activation function that does not have linear characteristics, and a representative non-linear activation function is the ReLU function. Non-linear activation functions are mainly used in layers containing convolution operations. The operation blocks in which the ReLU function is used are preset, and counting the number of non-linear activation functions is the same as counting the number of operation blocks set to use the ReLU function in the subnet. Therefore, the number of non-linear activation functions can be obtained with a very simple operation.

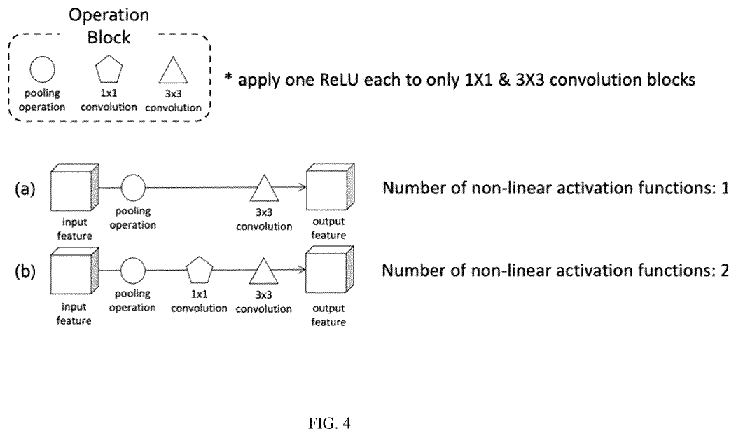

FIG. 4 is a diagram showing an example of counting the number of non-linear activation functions according to an embodiment of the present disclosure.

FIG. 4 shows an example of counting the number of non-linear activation functions when three operation blocks (pooling operation, 1×1 convolution operation, 3×3 convolution operation) are used and the number of layers is three. In FIG. 4, it is assumed that the non-linear activation function is applied only to the 1×1 convolution operation block and the 3×3 convolution operation block among the operation blocks.

Referring to the subnet shown in (a) of FIG. 4, the pooling operation block was selected for the first layer, the operation block was skipped for the second layer, and the 3×3 convolution operation block was selected for the third layer.

Since the non-linear activation function was applied only to the 3×3 convolution operation block, the number of non-linear activation functions of the subnet shown in (a) of FIG. 4 is ‘1’.

Referring to the subnet shown in (b) of FIG. 4, the pooling operation block was selected for the first layer, the 1×1 convolution operation block was selected for the second layer, and the 3×3 convolution operation block was selected for the third layer.

In the subnet shown in (b) of FIG. 4, since the non-linear activation function was applied to the 1×1 convolution operation block and the 3×3 convolution operation block, the number of non-linear activation functions of the subnet shown in (b) of FIG. 4 is ‘2’.

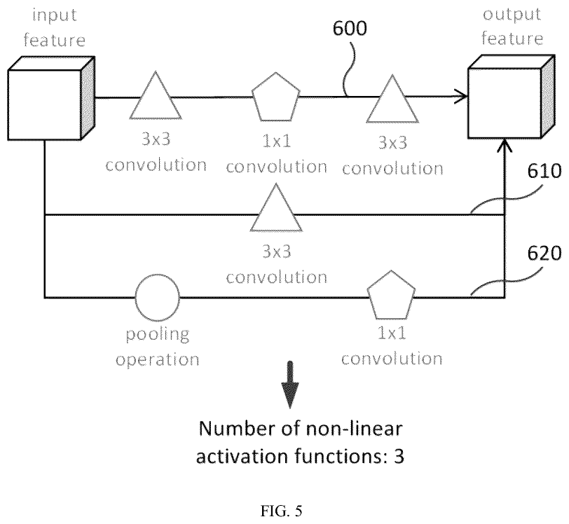

FIG. 5 is a diagram showing another example of counting the number of non-linear activation functions according to an embodiment of the present disclosure.

The subnet shown in FIG. 5 is a subnet that performs parallel neural network operations. There are three parallel paths 600, 610, and 620 in the subnet shown in FIG. 5. In the case of a subnet that performs parallel neural network operations, the path with the most non-linear activation functions among a plurality of paths is selected, and the number of non-linear activation functions in that path is counted. In a subnet that performs parallel neural network operations, the number of non-linear activation functions is not counted for the operation blocks of all paths.

Among the three parallel paths 600, 610, and 620 shown in FIG. 5, the first path 600 includes three convolution operation blocks, and the number of non-linear activation functions of the first path is three. The number of non-linear activation functions of the second path 610 is 1, and the number of non-linear activation functions of the third path 620 is 1.

Since the number of non-linear activation functions of the first path 600 is the largest, the number of non-linear activation functions of the subnet shown in FIG. 5 is set to 3, which is the number of non-linear activation functions of the first path 600.

In the same way as above, the number of non-linear activation functions for each subnet is counted, and since only the number of operation blocks set to use the non-linear activation function needs to be counted, the number of non-linear activation functions for each subnet can be obtained with a simple operation.

Referring again to FIG. 3, when the number of non-linear activation functions for each subnet is obtained, each subnet is grouped based on the number of non-linear activation functions (step 340). More specifically, subnets with the same number of non-linear activation functions are grouped into the same group. For example, subnets with a number of non-linear activation functions of 10 are grouped into the first group, and subnets with a number of non-linear activation functions of 15 are grouped into the second group.

In addition, the number of subnets included in the group is determined for each group (step 350). For example, the number of subnets in the first group is determined, which consists of subnets with 10 non-linear activation functions.

Once the number of subnets for each group is determined, it is possible to obtain a distribution of the number of subnets for each number of non-linear activation functions (for each group consisting of the same number of non-linear activation functions).

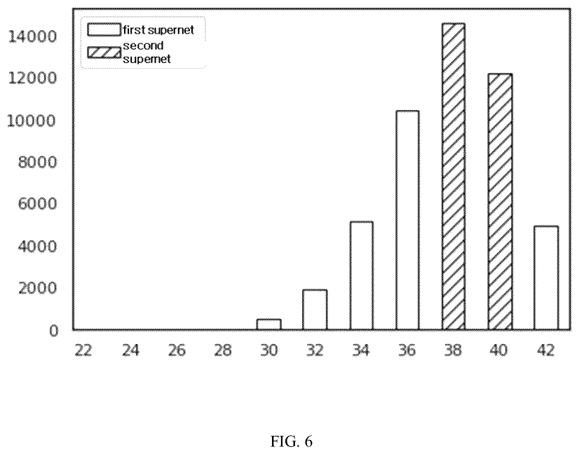

FIG. 6 is a graph showing an example of the distribution of the number of subnets for each subnet group according to an embodiment of the present disclosure.

Referring to FIG. 6, the x-axis is the subnet group index with the same number of non-linear activation functions. Of course, the x-axis may be the number of non-linear activation functions for each subnet group. The y-axis represents the number of subnets included in each subnet group. From another perspective, the y-axis could be defined as the frequency of occurrence of the number of non-linear activation functions associated with a subnet group.

For example, it can be seen that the number of subnets included in group 38, which consists of subnets with the same number of non-linear activation functions, is more than 14000.

Meanwhile, it can also be seen from the graph in FIG. 6 that the number of subnets belonging to groups with group indices 22 to 28 is extremely small.

Groups formed according to the number of non-linear activation functions are assigned to a preset number of supernets (step 360). For example, if the preset number of supernets is two, each group is assigned to two supernets. Subnets belonging to the same group are assigned to the same supernet. There may be various ways to assign a subnet group to a supernet. As an example, FIG. 6 shows a case in which a small number of groups with a large number of subnets are assigned to a first subnet, and the remaining groups are assigned to a second subnet. Of course, the method of assigning each subnet group to a supernet is not limited to this. Each subnet group simply needs to be assigned to the same supernet.

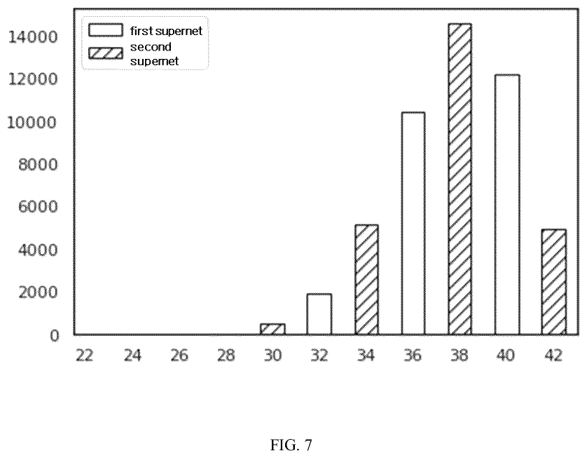

FIG. 7 is a diagram showing another example of assigning subnet groups to supernets according to an embodiment of the present disclosure.

As shown in FIG. 7, each group may be alternately assigned to different supernets according to its group index.

In this way, when a specific group is assigned to a specific supernet, the supernet consists of the operation blocks of the corresponding groups.

Once the assignment of each group to a supernet is completed and the operation block of each supernet is confirmed, multiple supernets are trained and a neural network with the optimal architecture is searched using the multiple supernets (step 370). When training a supernet and searching for an optimal subnet from a supernet, subnet search is performed to correspond to the non-linear activation function of the subnet group assigned to each supernet.

For example, assume that a first group with 10 non-linear activation functions and a second group with 20 non-linear activation functions are assigned to the first supernet. At this time, the first supernet extracts only subnets with 10 or 20 non-linear activation functions and performs training or performance evaluation.

The network search method using multiple supernets according to the present disclosure enables highly efficient neural network search with simple operations compared to the existing network search method using multiple supernets. The existing network search method using multiple supernets requires calculating the training gradient of the trained supernet to separate the search space, so considerable operation is required to separate the search space. However, according to the method of the present disclosure, the separation is possible simply by counting the number of non-linear activation functions of each subnet, grouping them, and assigning each group to a supernet, so it is possible to separate the search space for multiple supernets with simple operations.

In addition, since subnets with the same number of non-linear activation functions are assigned to the same supernet, each supernet of the present disclosure is made up of operation modules of subnets with similar topological properties, enabling more efficient neural network search.

The embodiment described with reference to FIG. 3 is an embodiment in which the number of supernets is set in advance. Rather than setting the number of supernets in advance, the number of supernets may be set ex post based on the distribution of the number of non-linear activation functions.

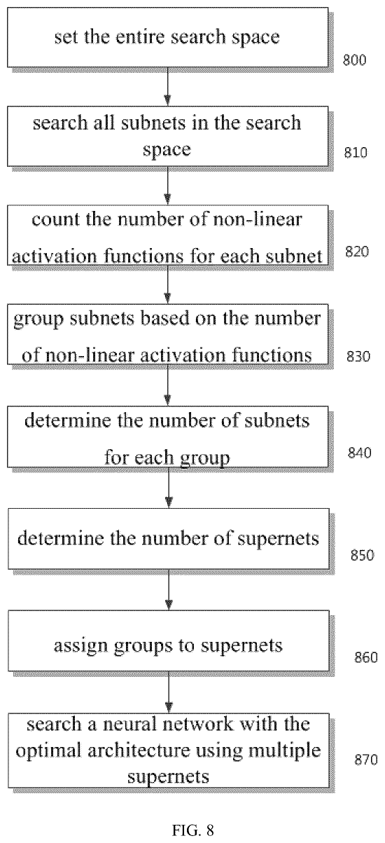

FIG. 8 is a flowchart showing the overall process of a neural network architecture search method using supernets according to another embodiment of the present disclosure.

Referring to FIG. 8, first, the entire search space is set (step 800). As in FIG. 3, the type of operation module, number of layers, kernel size of each operation module, etc. are set to the entire search space.

Once the search space is set, all subnets in the search space are searched (step 810). All subnets that can be extracted from the search space are searched in this step.

When subnet search is completed, the number of non-linear activation functions for each subnet is counted (step 820). The number of non-linear activation functions is counted for each subnet in the same manner as FIGS. 5 and 6.

Once the number of non-linear activation functions for each subnet is obtained, each subnet is grouped based on the number of non-linear activation functions (step 830). Subnets with the same number of non-linear activation functions are grouped into the same group.

When grouping of subnets is completed, the number of subnets included in the group is determined for each group (step 840).

Once the number of subnets for each group is determined, it is possible to obtain a distribution of the number of subnets for each number of non-linear activation functions (for each group consisting of the same number of non-linear activation functions).

Once the number of subnets included in each group is determined, the number of supernets is determined based on the number of subnets for each group (step 850).

According to an embodiment of the present disclosure, a critical value may be determined in advance, the number of subnet groups exceeding the critical value may be counted, and then the number of supernets may be determined to correspond to the number of groups exceeding the critical value.

For example, if there are three groups with the number of subnets (number of non-linear activation functions) exceeding the critical value, the number of supernets is set to three.

The number of supernets may be set based on distribution information of the number of subnets for each group. For example, if the variance values of the distribution of the number of subnets for each group is greater than the preset critical value, the number of supernets is set to a relatively large number, and if the variance values of the distribution of the number of subnets for each group is smaller than the preset critical value, the number of supernets is set to a relatively small number.

Once the number of supernets is determined, each group is assigned to the determined number of supernets (step 860).

If the number of supernets is set based on the number of groups exceeding the critical value of the number of non-linear activation functions associated with the group (the number of subnets included in the group), each group may become one supernet.

In addition, when the number of supernets is set based on the variance value of the distribution, groups may be assigned to supernets so that subnets of the same group are assigned to the same supernet.

Once the supernet assignment of each group is completed and the operation block of each supernet is confirmed, multiple supernets are trained and a neural network with the optimal architecture is searched using the multiple supernets (step 870). As described above, when training supernets and searching for an optimal subnet from the supernets, subnet search is performed to correspond to the non-linear activation functions of the subnet group assigned to each supernet.

Meanwhile, the neural network search method of the present disclosure described above may be executed by a neural network search device including a processor and memory. The neural network search device of the present disclosure is a computing device including a processor and a memory connected thereto, and the processor may execute the method shown in FIG. 3 or FIG. 9.

While the present disclosure is described with reference to embodiments illustrated in the drawings, these are provided as examples only, and the person having ordinary skill in the art would understand that many variations and other equivalent embodiments can be derived from the embodiments described herein.

Therefore, the true technical scope of the present disclosure is to be defined by the technical spirit set forth in the appended scope of claims.

What is claimed is:

1. A method for searching a neural network architecture, the method comprising the steps of:
(a) searching for subnets that can be extracted from a set search space;
(b) counting the number of non-linear activation functions included in each subnet for each of the searched subnets;
(c) grouping the searched subnets based on the counted number of non-linear activation functions;
(d) assigning the subnet groups to multiple supernets;
(e) searching for a neural network having an optimal architecture based on operation blocks of the subnet groups assigned to each of the multiple supernets.

2. The method for searching a neural network architecture according to claim 1,
wherein the step (c) includes grouping subnets with the same number of non-linear activation functions into the same group.

3. The method for searching a neural network architecture according to claim 1,
wherein the step (b) includes counting the number of non-linear activation functions by counting the number of operation blocks set to use the non-linear activation function among the operation blocks included in the extracted subnets.

4. The method for searching a neural network architecture according to claim 3,
wherein when the extracted subnet is a neural network having a parallel architecture, the number of non-linear activation functions is counted for each path of the parallel architecture, and the number of non-linear activation functions of the path having the largest number of non-linear activation functions among a plurality of paths is determined as the number of non-linear activation functions of the corresponding subnet.

5. The method for searching a neural network architecture according to claim 1,
wherein in step (d), subnets belonging to the same group are assigned to the same supernet.

6. The method for searching a neural network architecture according to claim 1,
wherein the number of supernets is determined for each subnet group based on the variance value of the distribution after obtaining the distribution of the number of subnets included in the group.

7. The method for searching a neural network architecture according to claim 1,
wherein in order to determine the number of supernets, groups including subnets greater than a preset critical value are searched among the plurality of groups grouped in step (c), and the number of groups including subnets greater than the preset critical value is determined as the number of supernets.

8. The method for searching a neural network architecture according to claim 1,
wherein in step (e), each of the multiple supernets extracts subnets corresponding to the number of non-linear activation functions associated with the group assigned to the corresponding supernet, thereby searching for a neural network having an optimal architecture.

9. A device for searching a neural network architecture, the device including:
a processor; and
at least one memory connected to the processor,
wherein the processor executes the steps of:
(a) searching for subnets that can be extracted from a set search space;
(b) counting the number of non-linear activation functions included in each subnet for each of the searched subnets;
(c) grouping the searched subnets based on the counted number of non-linear activation functions;
(d) assigning the subnet groups to multiple supernets;
(e) searching for a neural network having an optimal architecture based on operation blocks of the subnet groups assigned to each of the multiple supernets.

10. The device for searching a neural network architecture according to claim 9,
wherein the step (c) includes grouping subnets with the same number of non-linear activation functions into the same group.

11. The device for searching a neural network architecture according to claim 9,
wherein the step (b) includes counting the number of non-linear activation functions by counting the number of operation blocks set to use the non-linear activation function among the operation blocks included in the extracted subnets.

12. The device for searching a neural network architecture according to claim 11,
wherein when the extracted subnet is a neural network having a parallel architecture, the number of non-linear activation functions is counted for each path of the parallel architecture, and the number of non-linear activation functions of the path having the largest number of non-linear activation functions among a plurality of paths is determined as the number of non-linear activation functions of the corresponding subnet.

13. The device for searching a neural network architecture according to claim 9,
wherein in step (d), subnets belonging to the same group are assigned to the same supernet.

14. The device for searching a neural network architecture according to claim 9,
wherein the number of supernets is determined for each subnet group based on the variance value of the distribution after obtaining the distribution of the number of subnets included in the group.

15. The device for searching a neural network architecture according to claim 9,
wherein in order to determine the number of supernets, groups including subnets greater than a preset critical value are searched among the plurality of groups grouped in step (c), and the number of groups including subnets greater than the preset critical value is determined as the number of supernets.

16. The device for searching a neural network architecture according to claim 9,
wherein in step (e), each of the multiple supernets extracts subnets corresponding to the number of non-linear activation functions associated with the group assigned to the corresponding supernet, thereby searching for a neural network having an optimal architecture.
